(19) United States
(12) Patent Application Publication
(10) Pub. No.: US 2011/0218672 A1
(43) Pub. Date: Sep. 8, 2011

(54) Robot Capable of Exchanging Behavior-Coding Computer Programs

(75) Inventors: Bruno Maisonnier, Paris (FR); Fabien Bardinet, Issy-les-Moulineaux (FR)

(73) Assignee: ALDEBARAN ROBOTICS S.A, Paris (FR)

(21) Appl. No.: 12/677,985

(22) PCT Filed: Aug. 7, 2008
(86) PCT No.: PCT/EP2008/060372

§ 371 Date: Sep. 10, 2010

(30) Foreign Application Priority Data
Sep. 12, 2007 (FR) 07/ 06387

(51) Int. Cl. G06F 15/18; B25J 9/16

(52) U.S. Cl. 700/246; 901/6

(57) ABSTRACT

The invention relates to a robot comprising storage means designed to store at least one computer program which, when executed, causes the robot to act according to a particular behavior, characterized in that it comprises loading means able to load, from remote computer equipment, a computer program which, when executed, causes the robot to act according to a particular behavior, and saving means able to save the duly loaded computer program in said storage means. Said loading means are designed to transmit a load request to the remote equipment to initiate the loading of the computer program from the remote equipment. The robot comprises at least one memory for storing evolution parameters, and the loading means are also designed to transmit the request according to the evolution parameters.

The invention relates to a robot comprising storage means designed to store at least one computer program which, when executed, causes the robot to act according to a particular behavior.

In a manner known per se in the field of humanoid robotics, robot behaviors can correspond to the activation of one or more motors to control members of the robot, when one or more computer applications are triggered to initiate, for example, the reading of a music track, or the taking of a photograph when the robot has a built-in camera, and the recognition of external stimuli detected by sensors. The computer programs stored in the storage means then make it possible to cause the robot to act according to such behaviors when they are executed, possibly in response to stimuli received by the robot.

The invention relates more particularly to a robot as described hereinabove whose behaviors are likely to evolve over time.

Robots whose behaviors are likely to evolve over time are known in the state of the art.

To produce the evolution over time, it is known to load into a memory of the robot a computer program comprising instructions enabling the robot to learn. This type of computer program is commonly called artificial intelligence software and is widely used to produce robots, humanoid or otherwise. Thanks to this artificial intelligence software, the robot reacts to different external stimuli and, depending on the stimuli received, can evolve over time.

However, even in the case of complex artificial intelligence software, the number of behaviors that can be produced by the robot is limited by the computer programs stored in the storage means defined hereinabove. Consequently, a user using the robot as a kind of intelligent game might soon become bored with the robot if it constantly reproduces the same behaviors. This is obviously a drawback in the known robots.

The problem resolved by the invention is how to improve the evolution capabilities of the robot.

More particularly, the problem that is resolved is how to enable evolution of the robot over time in a permanent manner, so as to better simulate the evolution of a living being, and render the robot much more interesting over time.

This problem is resolved by the fact that the robot comprises loading means able to load from remote computer equipment a computer program which, when executed, causes the robot to act according to a particular behavior, and saving means able to save the duly loaded computer program in said storage means.

Thanks to the invention, the robot can therefore produce new behaviors and therefore continually extend its range of behaviors. Consequently, its evolution is assured by the invention and, if the loaded program is able to cause the robot to act according to a new behavior, it will produce new actions.

The idea of exchanging computer programs between remote entities is known in the computer field. In particular, it is known that a first computer requests, on a remote server, a computer program to perform a software update. However, such an exchange of computer programs has never been applied to the technical field of robotics for a robot to be able to act according to new behaviors.

According to one embodiment of the invention, the loading means are designed to transmit a load request to the remote equipment to initiate the loading of the computer program from the remote equipment.

This way, by transmitting the request, it is the robot that takes the initiative for loading the computer program, and it does so without the intervention of the human holder of the robot at the time of loading.

Preferably, the request comprises data relating to the actions that can be produced by the robot. This way, the computer program to be loaded can depend on the action capabilities of the robot. It will then be possible to ensure that the new behaviors loaded by the robot are all compatible with the capabilities of the robot.

In order to allow for the evolution of the robot to be controlled, the robot preferably comprises at least one memory for storing evolution parameters, and the loading means are designed also to transmit the request according to the evolution parameters.

The evolution parameters preferably comprise subscription data determining the number of requests likely to be transmitted to the remote equipment.

In order to simulate a natural evolution of the robot, the loading means are advantageously designed to automatically initiate the loading of the computer program.

The robot can comprise behavior generation means designed for the robot to produce, when they are activated, behaviors, the computer program being able, when executed, to cause the robot to act according to at least one behavior of the robot by activating said behavior generation means. This notably makes it possible to generate new movements of the robot, or reactions to new stimuli.

In particular, said behavior generation means preferably comprise moving parts controlled by motors, and the computer program may be able to cause the robot to act according to at least one particular behavior by activating at least one of said motors so as to displace at least one of the moving parts.

The robot can also comprise applications, and the computer program is in this case able to cause the robot to act according to at least one behavior by activating at least one of said applications.

The robot can also comprise transmission means designed to initiate the transmission of the computer program stored in the storage means to the remote equipment. This way, the robot can both receive and transmit behavior-coding computer programs, which has the advantage of also enabling the evolution of other robots.

The invention also relates to a robot comprising storage means designed to store at least one computer program which, when executed, causes the robot to act according to at least one particular behavior, the robot being characterized in that it comprises transmission means designed to initiate the transmission of the computer program stored in the storage means to remote equipment, so as to enable the computer program to be loaded from the remote equipment by the loading means of a robot as described previously.

This way, it is possible to train a community of robots exchanging programs making it possible to execute new behaviors. Consequently, if a new program enabling a new behavior to be executed has been defined for a robot of the community, this program can be exchanged between the robots of the community so that the evolution of all the robots of the community can be assured.

The invention also relates to a system comprising a robot as described previously, and computer equipment comprising storage means designed to store computer programs able, when executed, to cause the robot to act according to at least one particular behavior, computer programs duly stored in the storage means, and transmission means designed to transmit the computer program to the robot when the loading from the remote equipment is initiated by the loading means of the robot.

According to one embodiment of the system described previously, the remote computer equipment comprises selection means designed to determine whether the robot is capable of producing the behavior coded by the computer program to be loaded to the robot.

This way, the new behaviors loaded by the robot are all compatible with the capabilities of the robot.

Preferably, the selection means are able to determine whether the robot is capable of producing the behavior coded by the computer program to be loaded to the robot according to data in the request.

The invention also relates to a method for making a robot evolve, comprising steps in which:

the robot loads, from remote computer equipment, a computer program able to cause the robot to act according to a particular behavior,

the robot saves, in storage means, the duly loaded computer program so as to be able to cause the robot to act according to the behavior when the computer program is executed.

Preferably, the step in which the robot loads the computer program comprises steps in which:

the robot transmits a request to the remote computer equipment;

the computer equipment transmits the computer program to the robot in response to the request.

Preferably, the step in which the computer equipment transmits the computer program to the robot in response to the request comprises steps in which:

the computer equipment analyzes the request so as to determine whether the robot is able to execute the computer program;

the computer equipment transmits the computer program if the robot is able to execute it.

In order to train a community of robots allowing for a simple evolution of the robots, the method described previously preferably comprises steps in which:
a first robot stores, in storage means, the computer program which, when executed, causes the first robot to act according to a particular behavior;

the first robot transmits the computer program to remote equipment;

the remote equipment stores the computer program in storage means;

a second robot loads the computer program duly transmitted from the remote equipment.

In this method, the robot can execute the duly loaded computer program so as to produce the behavior.

There now follows a description of an embodiment of the invention with reference to the appended figures in which:

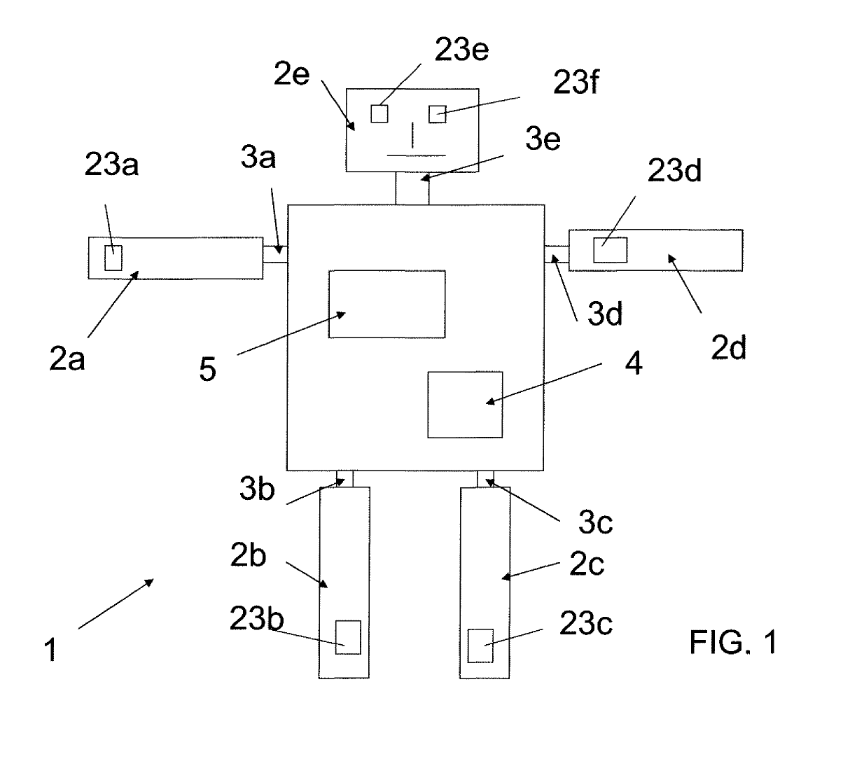

FIG. 1 represents a robot according to one embodiment of the invention;

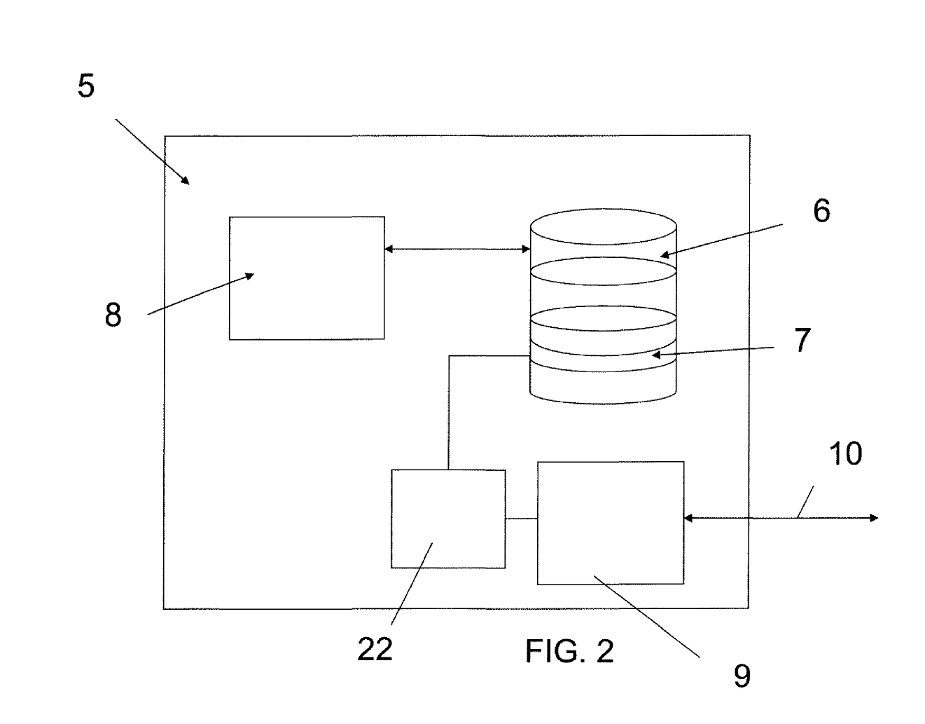

FIG. 2 represents a detailed embodiment of the central unit of the robot described with reference to FIG. 1;

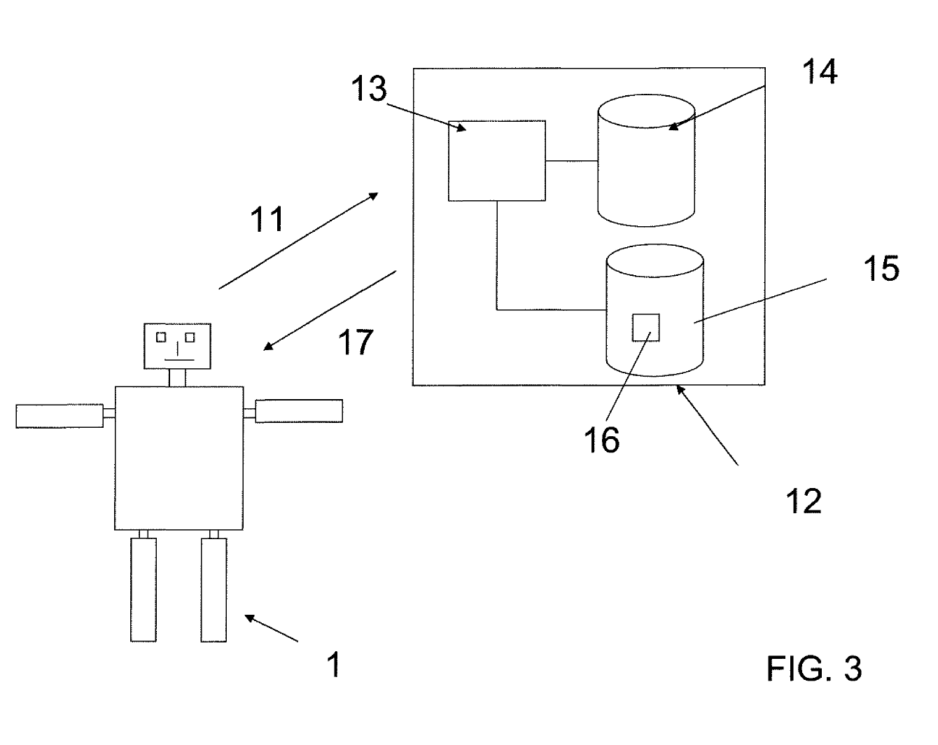

FIG. 3 represents the loading of a behavior-coding computer program by the robot illustrated in FIG. 1 from remote equipment;

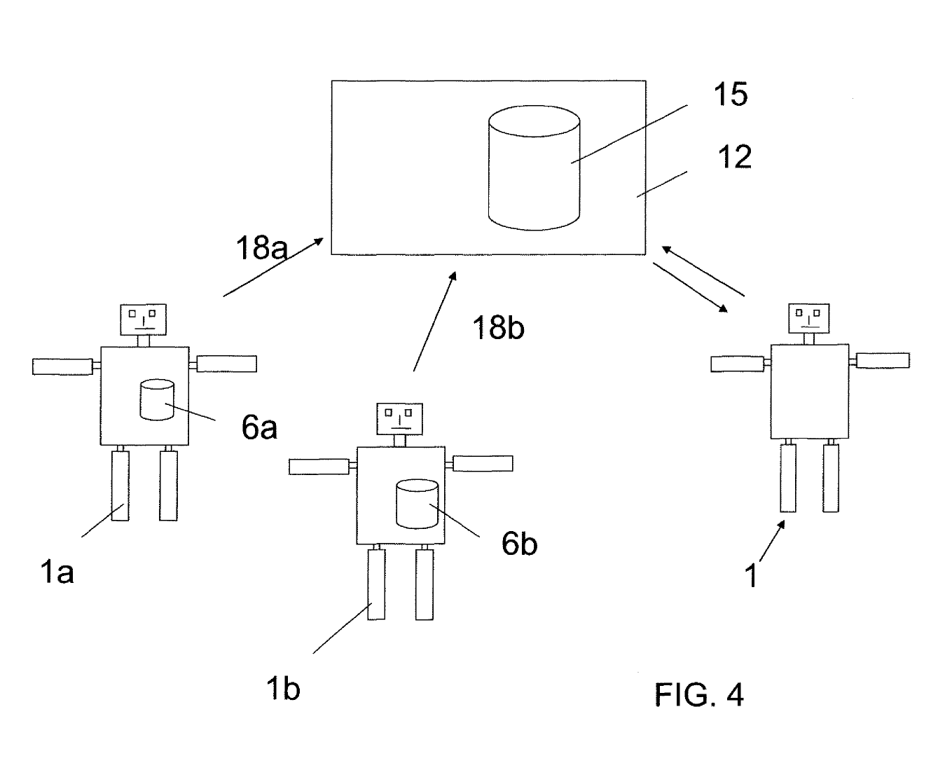

FIG. 4 represents a community of robots according to the invention that are able to exchange behavior-coding computer programs;

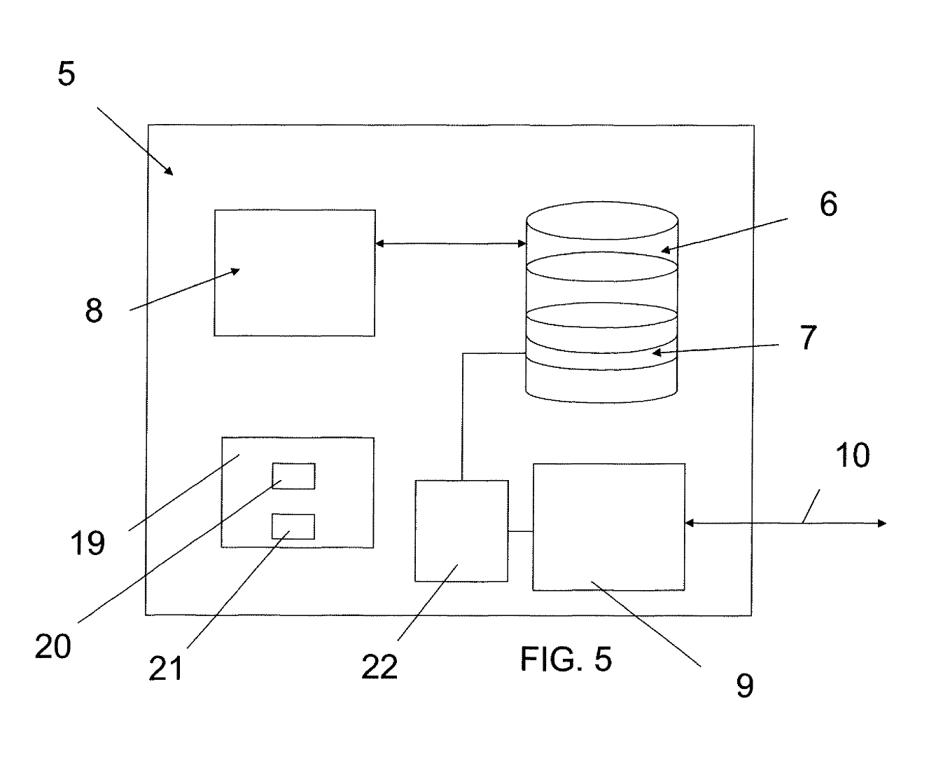

FIG. 5 represents another embodiment of the central unit of the robot described with reference to FIG. 1.

In the figures, identical references represent similar technical characteristics.

As illustrated in FIG. 1, a robot 1 according to the invention comprises one or more moving parts 2a to 2e, and a set of sensors 23a to 23f. When the robot 1 is a humanoid robot, moving parts 2a to 2e correspond to the members of a human. In FIG. 1 for example, the moving parts 2a and 2d correspond to arms of the robot 1, the moving parts 2b and 2c to legs, and the part 2e to a head. All the moving parts are able to be displaced thanks to articulations 3a to 3e comprising respective motors. When the motors of the articulations 3a to 3e are activated, they move the moving parts 2a to 2e so that the robot 1 can produce different behaviors.

A behavior of the robot 1 can also be produced thanks to one or more applications 4. For example, the application 4 may correspond to the act, for the robot, of taking a digital photograph using a built-in digital camera, to producing facial recognition using a facial recognition application, or any other application involving an action without necessarily displacing the moving parts 2a to 2e.

The production of a behavior of the robot 1 can also correspond to a reaction to stimuli picked up by the sensors 23a to 23f.

The production of behaviors of the robot, that is to say the displacement of the moving parts 2a to 2e via the activation of the articulations 3a to 3e, the launching of an application 4, and everything possibly in response to stimuli picked up by the sensors 23a to 23f, is controlled by a central unit 5.

The central unit 5 is described in more detail in FIG. 2.

The central unit 5 comprises processors and memories that are not represented for executing series of computer program instructions. It also comprises an operating system that is not represented. The components described hereinbelow interact in a manner known per se with the processors and the memories to produce the described functions.

The central unit also comprises a behavior database 6. This database of computer programs 7 able to cause the robot 1 to act according to particular behaviors. These computer programs 7 comprise instructions which, when executed by the processors of the robot, initiate a particular activation of the articulations 3a to 3e, which provokes movements of the moving parts 2a to 2e, or process the information obtained from the sensors 23a to 23f. They can also initiate the activation of the applications 4. Consequently, when a computer program 7 from the database 6 is executed, the robot 1 produces a particular behavior associated with the computer program 7.

The central unit 5 also comprises an artificial intelligence unit 8 which cooperates with the database 6 to determine the behavior that the robot 1 should have at a given instant, that is to say, the computer program 7 which must be executed at a given instant. The artificial intelligence unit comprises an artificial intelligence computer program that is known per se and allows for a selection of the appropriate behaviors according to external stimuli picked up by sensors of the robot 1, or according to a preprogrammed behavior objective.

The central unit 5 also comprises data exchanging means 9 designed to transmit data from the robot 1 to remote computer equipment, and to receive data from that remote computer equipment. These data exchanging means comprise, for example, a WiFi wireless network communication card, or a wired network communication card. This way, data can be exchanged via a transmission channel 10 to and from the world outside the robot.

The central unit 5 also comprises a saving module 22 which can be used to recover the data received by the data exchanging means 9 to store said data in the database 6.

There now follows a detailed description of how the evolution of the robot 1 works, with reference to FIG. 3.

Thanks to the data transmission means 9 described hereinabove, the robot 1 transmits a request 11 to remote computer equipment 12. In addition to the means described in detail hereinbelow, the remote computer equipment comprises processors and memories that are not represented to execute series of computer program instructions. The components described hereinafter interact in a manner known per se with the processors and the memories to carry out the functions described.

The aim of the request 11 is to receive from the remote equipment 12 a new computer program with which to provide the robot with a new behavior. The request 11 notably comprises an identifier of the robot 1.

The request 11 is received at the remote equipment 12 which also comprises wired or wireless data transmission means suited to the data transmission means 9 of the robot. The request 11 is then analyzed by behavior selection means 13. These behavior selection means 14 read the identifier in the request 11 so as to identify the robot 1. Using this identifier, the selection means 13 determine, from a first database 14, the technical characteristics of the robot 1 having transmitted the request 11 in order for the new behavior to be adapted to the actions that can be produced by the robot 1.

In addition, instead of or in addition to the identifier of the robot 1, the request 11 can also comprise data relating to the actions that can be produced by the robot. Such data, for example, takes the form of a list of the components of the robot 1 likely to be activated when a computer program is executed. This list may, for example, comprise an identifier of the sensors 23a to 23f, and/or of the moving parts 2a-2e, and/or of the applications 4.

For example, if the leg 2b of the robot 1 does not include any articulation at knee level, and the request 11 is a request to obtain a new behavior for the leg, the selection means 13 will identify that the robot 1 does not include any knee articulation and will select only the leg behaviors that do not include movement at the level of the articulation of the knee. The selection means 13 therefore make it possible to adapt the new behaviors to the physical characteristics of a robot 1 that sends requests 11.

Once the robot 1 is identified and any behaviors that are incompatible with the physical characteristics are excluded by the selection means 13, the selection means 13 recover from a behavior database 15, a computer program enabling the robot 1 to act according to a particular behavior.

Like the database 7 included in the robot 1, the behavior database 15 comprises computer programs 16 that comprise instructions which, when executed by the processors of the robot, initiate behaviors of the robot. The computer programs 16 likely to be loaded by the robot 1 can also comprise computer modules that the robot 1 needs to execute functions invoked by certain instructions of the computer program 16.

Once the computer program 16 has been selected, it is transmitted 17 by the remote equipment 12 to the robot 1 having sent the request 11. The computer program is then received by the robot thanks to the data exchanging means 9. The saving means 22 then instigate the saving of the computer program 16 in the database 6. Consequently, the computer program 16 can be accessed by the artificial intelligence unit 8 for the robot 1 to produce a new behavior corresponding to the instructions contained in the computer program 16. As previously, this new behavior may be a particular activation of the articulations 3a to 3e, which provokes movements of the moving parts 2a to 2e. They may also initiate the activation of the applications 4. Consequently, when the new computer program 16 from the database 6 is executed, the robot 1 produces this new particular behavior associated with the computer program 16.

There now follows a description of how the computer programs 16 are loaded from the database 15 of the remote equipment 12.

According to one embodiment of the invention illustrated in FIG. 4, the computer programs 16 in the database 15 of the remote equipment 12 are received from robots 1a and 1b training, with the robot 1, a community of compatible robots. Thus, like the robot 1, the robots 1a and 1b include a database 6a and 6b comprising computer programs which, when executed, respectively enable the robots 1a and 1b to produce behaviors by activation of the motors of their articulations or their applications. The robots 1a and 1b also each comprise transmission means designed to transmit these behavior-coding computer programs to the remote equipment 12. Thus, in a step 18a, the robot 1a transmits one or more computer programs from its database 6a to the equipment 12, and in a step 18b, the robot 1b transmits one or more computer programs from its database 6b to the equipment 12. These computer programs are stored in the database 15 of the remote equipment 12, and can then be accessed by the robot 1 via a request as described previously.

Similarly, the robots 1a and 1b can be designed like the robot 1 described previously to receive new behavior-coding computer programs for new behaviors from the remote equipment 12. Furthermore, the robot 1 may be designed like the robots 1a and 1b and allow for the transmission of the computer programs 7 stored in the database 6.

Consequently, it will be understood that the possibilities of evolution of the robots according to the invention, thanks to the community trained by the robots 1, 1a and 1b, are very great. In practice, if the possessor of the robot 1a develops, for his robot 1a, a new behavior-coding computer program for a new behavior, the entire community of the robots, and notably the robots 1b and 1, can benefit from this new behavior by receiving the new computer program from the remote equipment 12 since the database 15 of the remote equipment 12 contains all the behavior-coding computer programs 16 for all the behaviors likely to be produced by the robots 1a, 1b, 1 of the community of robots. Thus, a community of programmers can continually increment and improve the database 15 to have the robots of the community evolve.

There now follows a description of how the requests 11 from the robot 1 to receive a computer program 16 from the database 15 of the computer equipment 12 are triggered.

According to one embodiment of the invention, the requests 11 can be triggered periodically automatically by the robot 1. For this, instructions are programmed, for example in the artificial intelligence unit 5, to trigger requests 11a certain number of times a day, for example 3 times. However, if the number of requests 11 sent by the robot is not limited, there is a risk that the robot will evolve too strongly and in a manner that is uncontrolled by its holder.

According to another embodiment of the invention illustrated in FIG. 5, the number of requests 11 transmitted by the robot 1 is determined by a subscription to the remote equipment 12. For this, instructions are programmed, for example in a memory area 19 of the central unit 5, to trigger requests 11a number of times equal to a dynamic parameter that can be modified according to the subscription. The subscription is then produced by the holder of the robot 1 who subscribes to the remote equipment 12, for example by means of a web interface, for a determined number of requests. Once the remote equipment 12 has received these subscription instructions, it transmits the subscription parameter to the robot 1 for the number of requests to the remote equipment 12 to be limited to this parameter. The subscription parameter 20 is stored in the memory area 19. When a request 11 is sent by the robot 1, the remote equipment 12 then compares the number of requests already sent and accepts the transmission of a program 16 only if the maximum number of requests determined by the subscription has not been reached. If a program 16 is transmitted to the robot 1, the remote equipment 12 decrements a request counter to take account of the program 16 transmitted.

Furthermore, beyond the number of requests 11 likely to be transmitted by the robot 1, the type of requests 11 transmitted may also be preprogrammed in the form of a life objective of the robot or be subject to a subscription. For example, it is possible to preprogram, in the robot 1, the fact that the life objective of the robot 1 is to be a dancing robot. Consequently, the requests 11 from the robot 1 can be limited to requests regarding dance behaviors, or music. The life objective is, for example, stored in the form of a parameter 21 in the memory area 19 of the robot 1.

The subscription parameters 20 and the life objective parameters 21 then form evolution parameters determining the evolution of the robot 1.

Similarly, when they receive the request 11, the selection means 13 can, when they identify the robot 1, identify that the robot 1 is a dancing robot, and select as priority the dance-behavior-coding computer programs 16.

The artificial intelligence unit 8 is then used to automatically initiate the transmission of a request 11 and therefore the loading of a computer program 16 from the database 15 of the equipment 12 according to the subscriptions and preprogrammed life objectives of the robot 1.

According to one embodiment of the invention, it is possible for the computer program transmitted, for example by the robot 1a, to be transmitted directly to the robot 1. Consequently, in this case, the request 11 is sent by the robot 1 directly to the robot 1a, and the remote equipment 12 merges with the robots 1, 1a and 1b themselves. However, this embodiment has the drawback of preventing any control over the type of computer programs that will be exchanged by the robots, so that it will not be possible to control the behaviors of the robots. In practice, in the absence of any external control, if a programmer were to generate a behavior-coding computer program for a behavior that is dangerous to a robot, this robot could then transmit this dangerous behavior to other robots.

Consequently, according to a second preferred embodiment of the invention, the remote equipment 12 is always separate from the robots 1, 1a and 1b and the behavior-coding computer programs pass through the remote equipment 12 before they can be loaded by a robot. On the computer equipment 12, it is then possible to carry out a check on the computer programs received from the robots to make sure that they do not code dangerous behavior. Thus, for the exchange of behaviors between a first robot 1a and a second robot 1, the first robot 1a stores, in its database 6a, a computer program 7 which, when executed, causes the first robot 1a to act according to a particular behavior, the first robot 1a transmits the computer program 7 to the remote equipment 12, and a second robot, for example the robot 1, loads the duly transmitted computer program, from the remote equipment 12.

1. A robot comprising storage means designed to store at least one computer program which, when executed, causes the robot to act according to a particular behavior, comprising loading means able to load, from remote computer equipment, a computer program which, when executed, causes the robot to act according to a particular behavior, and saving means able to save the duly loaded computer program in said storage means said loading means being designed to transmit a load request to the remote equipment to initiate the loading of the computer program from the remote equipment, said request comprising data relating to the actions that can be produced by the robot, wherein the robot comprises at least one memory for storing parameters for automatically triggering load requests initiated by the single robot.

2. The robot as claimed in claim 1, wherein said parameters for triggering a load request comprise life objective parameters.

3. The robot as claimed in claim 2, wherein at least one life objective is defined by a set of behaviors to be produced by the robot.

4. The robot as claimed in claim 1 wherein said parameters for triggering a load request comprise subscription parameters to which the user of the robot has subscribed.

5. The robot as claimed in, comprising behavior generation means designed for the robot to produce, when they are activated, behaviors of the robot, the computer program being able, on execution, to cause the robot to act according to at least one behavior by activating said behavior generation means.

6. The robot as claimed in claim 5, wherein said behavior generation means comprise moving parts controlled by motors, and wherein the computer program is able to cause the robot to act according to at least one behavior by activating at least one of said motors so as to move at least one of the moving parts.

7. The robot as claimed in claim 6, wherein the behavior generation means comprise applications and wherein the computer program is able to produce at least one behavior by activating at least one of said applications.

8. The robot as claimed in claim 1, further comprising the duly loaded computer program stored in the storage means.

9. The robot as claimed in claim 1, further comprising transmission means designed to initiate the transmission of the computer program stored in the storage means to the remote equipment.

10. A robot comprising storage means designed to store at least one computer program which, when executed, causes the robot to act according to at least one particular behavior, wherein the robot comprises transmission means designed to initiate the transmission of the computer program stored in the storage means to remote equipment, so as to enable the computer program to be loaded from the remote equipment by the loading means of a robot as claimed in claim 1.

11. A system comprising a robot as claimed in claim 1, and computer equipment comprising storage means designed to store computer programs able to cause the robot to act according to at least one particular behavior, computer programs stored in said storage means, and transmission means designed to transmit the computer program to the robot when the loading from the remote equipment is initiated by the loading means of the robot.

12. The system as claimed in claim 11, wherein the computer equipment comprises selection means designed to determine whether the robot is capable of producing the behavior coded by the computer program to be loaded to the robot.

13. The system as claimed in claim 12, wherein the selection means are able to determine whether the robot is capable of producing the behavior coded by the computer program to be loaded to the robot according to data in the request.

14. A method for making a robot evolve, comprising steps in which:
the robot loads, from remote computer equipment, a computer program able to cause the robot to act according to a particular behavior,
the robot saves, in storage means, the duly loaded computer program, so that the robot can act according to the behavior when the computer program is executed,
said step in which the robot loads the computer program comprising steps in which:
the robot transmits a request comprising data relating to the actions that can be produced by the robot, to the remote computer equipment, automatically at the initiative of the single robot, according to parameters for triggering load requests stored in a memory;
the computer equipment transmits the computer program to the robot in response to the request,
and said step in which the computer equipment transmits the computer program to the robot in response to the request comprising steps in which:
the computer equipment analyzes the request so as to determine whether the robot is able to execute the computer program;
the computer equipment transmits the computer program if the robot is able to execute it.

15. The method as claimed in claim 14, wherein
a first robot stores, in storage means, the computer program which, when executed, causes the first robot to act according to a particular behavior;
the first robot transmits the computer program to remote equipment;
the remote equipment stores the computer program in storage means;
a second robot loads the computer program duly transmitted from the remote equipment.

16. The method as claimed in claim 14, wherein the robot executes the duly loaded computer program so as to produce the behavior.

17. A robot as claimed in claim 1, wherein the subscription parameters comprise the number of requests likely to be transmitted to the remote equipment.
